(19) United States
(12) Patent Application Publication
(10) Pub. No.: US 2006/0196059 A1
(43) Pub. Date: Sep. 7, 2006

(54) Device for graphically showing a schedule

(76) Inventor: Joseph Berto, White City, OR (US)

Correspondence Address: BUCHANAN INGERSOLL PC, POST OFFICE BOX 1404, ALEXANDRIA, VA, 22313-1404, US

(21) Appl. No.: 11/073,193

(22) Filed: Mar. 4, 2005

(51) Int. Cl. G01C 15/00

(52) U.S. Cl. 33/286

(57) ABSTRACT

A projection device that graphically shows a schedule, which includes at least one light source adapted to emit a beam of light and an aiming device adapted to receive the beam of light and project the beam of light onto a surface. The projection device produces a plurality of illuminated points or segments corresponding to a schedule.

### FIELD OF THE INVENTION

The invention generally relates to a system and method for graphically showing a schedule, using illuminated points of light, for mounting wallboard, nailing decking on studs, laying tile or any application where a schedule along a segmented line is desired.

### BACKGROUND OF THE INVENTION AND BRIEF DESCRIPTION OF THE RELATED ART

For some time laser beams have been used in construction for level references, vertical references and layout on floors and walls. Typically a construction worker marks the floor or walls indicating the location of walls, windows, or other building elements to be constructed. A chalk line is often used to visually mark the walls or floors by holding one end of the chalked string and snapping it, releasing chalk dust, which makes the mark.

The most common prior laser devices are a simple carpenter's level with level vials and with a laser beam projector attached, a mountable device displaying a dot or line or an attachable device that uses a continuous sweep to display a line. These levels do an excellent job of projecting a beam on a floor or wall, and can project either a point of illumination or a line on a surface. However, none of these devices are configurable to display multiple or intermittent illuminated points or a segmented line.

Laser-based devices optical system have also been designed for roller and bearing alignment, geometric alignment, positioning tracks and rails, measuring run-out on slides and machine tools, checking surface flatness of machine beds, bore and shaft alignment, straightness and parallelism checking on long machines, and squaring gantry rails and cross bridges

However, it would be desirable to have a device that graphically shows a schedule that can be used for fastener spacing when mounting wallboard such as drywall, nailing decking to show spacing between studs or joists, laying out tile, hanging framed artwork, positioning multiple machines, laying out fences, stitching quilts in material or any application where a consistent distance between points is desired.

### SUMMARY OF THE INVENTION

In accordance with one embodiment, a projection device that graphically shows a schedule comprising: at least one light source adapted to emit a beam of light; and an aiming device adapted to receive the beam of light and project the beam of light onto a surface, wherein the projection device produces a plurality of illuminated points or segments corresponding to a schedule.

In accordance with another embodiment, a device that graphically shows a schedule comprising: at least one light source adapted to emit an intermittent visible beam of light; an electronic assembly adapted to control the intermittent timing of the emission of the beam of light by the light source; and a motor assembly adapted to rotate the light source through a plurality of positions, and project the intermittent beam of light onto a surface in the form of individual points of illumination corresponding to a schedule.

In accordance with a further embodiment, a device that graphically shows a schedule comprising: at least one light source adapted to emit an intermittent visible beam of light; a mirror configured to receive the beam of light; a motor assembly adapted to rotate the mirror assembly through a plurality of positions; an electronic assembly adapted to control the intermittent timing of the emission of the beam of light by the light source; and wherein the mirror receives the beam of light and projects the beam of light onto a surface in the form of individual points of illumination or segments corresponding to a schedule.

In accordance with another embodiment, a device that graphically shows a schedule comprising: at least one light source adapted to emit a visible beam of light; a laser line generator adapted to convert the beam of light into a line of light; an aperture assembly configured to control the emission of the beam of light; and wherein the beam of light is beamed onto a surface in the form of a plurality of individual points of illumination or segments corresponding to a schedule.

In accordance with a further embodiment, a device that graphically shows a schedule comprising: at least one light source emitting a visible beam of light; a mirror configured to receive the beam of light, wherein the mirror receives the beam of light and projects the beam of light; a motor assembly adapted to rotate the mirror through a plurality of positions; an aperture assembly configured to control the emission of the beam of light; and wherein the beam of light is beamed onto a surface in the form of a plurality of individual points of illumination or segments corresponding to a schedule.

In accordance with another embodiment, a device that graphically shows a schedule comprising: at least one light source adapted to emit a visible beam of light; a motor assembly adapted to rotate the light source through a plurality of positions; an aperture assembly configured to control the emission of the visible beam of light; and wherein the visible beam of light is beamed onto a surface in the form of a plurality of individual points of illumination or segments corresponding to a schedule.

### BRIEF DESCRIPTION OF THE DRAWINGS

The invention will now be described in greater detail with reference to the preferred embodiments illustrated in the accompanying drawings, in which like elements bear like reference numerals, and wherein:

FIG. 1 shows a perspective view of a device that graphically shows a schedule.

FIGS. 2A-2C shows a cross sectional view of an embodiment of the device of FIG. 1 comprising a light source and a mirror assembly.

FIG. 3 shows a cross sectional view of a further embodiment of the device of FIG. 1 comprising a light source and a lens assembly.

FIG. 4 shows a cross sectional view of another embodiment of the device of FIG. 1 comprising a light source, a beam spreader in the form of a laser line generator and an aperture.

FIG. 5A shows a cross sectional view of a further embodiment of the device of FIG. 1 comprising a plurality of light sources.

FIG. 5B shows a cross sectional view of another embodiment of the device of FIG. 1 comprising a plurality of adjustable light sources.

FIG. 5C shows a cross sectional view of a further embodiment of the device of FIG. 1 comprising a plurality of light sources and an aiming device.

FIG. 6 shows a cross sectional view of another embodiment of the device of FIG. 1 comprising a light source and a plurality of lenses.

FIG. 7A shows a cross sectional view of the mirror assembly of FIGS. 2A-2C.

FIG. 7B shows a cross sectional view of a rotatable light source and motor assembly.

FIG. 8A shows a cross sectional view of a further embodiment of the device of FIG. 1 having a rotatable light source and an aperture.

FIG. 8B shows a cross sectional view of a further embodiment of the device of FIG. 1 having a light source, a rotatable mirror assembly and an aperture.

FIGS. 9A and 9B show a cross sectional view of the device of FIG. 1 having a calibration system and an index point.

FIG. 10 shows a perspective view of another embodiment of a device for graphically showing a schedule.

FIG. 11 shows a perspective view of the device of FIG. 1 graphically showing a schedule for mounting wallboard to a stud.

FIG. 12 shows a perspective view of a housing configured to contain the device of FIG. 1.

FIG. 13 shows a perspective view of the device of FIG. 1 graphically showing a fastener spacing schedule for mounting wallboard to a stud or joist.

FIG. 14 shows a plurality of illuminated points of light forming a grid.

### DETAILED DESCRIPTION OF THE PREFERRED EMBODIMENTS

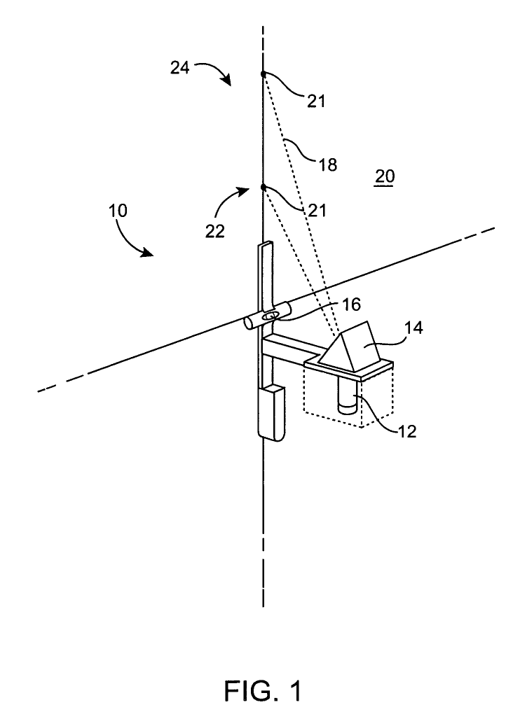

FIG. 1 shows a perspective view of a device 10 for graphically showing a spacing of individual points of light (schedule) 24. The device 10 can be used for laying out fastener spacing when mounting wallboard such as drywall, nailing decking to show spacing between studs or joists, laying out tile, or any application where a schedule 24 is desired.

As shown in FIG. 1, the device 10 comprises a light source 12 and an aiming device 14. In operation, the light source 12 is adapted to emit a visible or coherent beam of light 18, which the aiming device 14 receives and projects the beam of light 18 onto a surface 20. For example as shown in FIG. 1, the surface 20 can be a sheet of wallboard, wherein the projection device 10 beams the light as a plurality of individual beams 22 corresponding to a schedule 24 for attaching the wallboard to a framing member (not shown) such as a wall stud or joist. In addition, it can be appreciated that the device 10 can be used with any material, including fabrics, wood, stone, concrete, earth, where a schedule 24 needs to be accommodated.

The light source 12 can be any suitable source of visible or coherent light. However, the light source 12 is preferably a laser light device, or light amplification by stimulated emission of radiation. One advantage of using a laser light device as the light source 12 is lasers produce a very directional and a very strong and concentrated beam of light and any suitable laser device can be used. Typically, a laser light is monochromatic, i.e., it contains one specific wavelength of light (one specific color), which is determined by the amount of energy released when the electron drops to a lower orbit. Accordingly, the light source 12 can produce different visible wavelengths of light, which correspond to different colors of light beams. Any suitable color can be used; however, orange, red and green are preferable for most uses.

The aiming device 14 receives the visible beam of light 18 and projects the beam of light 18 onto a surface 20. The projection device beams the light 18 as a plurality of individual beams 22 corresponding to a schedule 24. It can be appreciated that the schedule 24 can be repeatable, wherein the distance between each individual beam of light 22 on the surface 20 is the identical to the previous beam of light 22 or alternatively, the distance between each beam of light 22 can be variable. In addition, it can be appreciated that any number of light sources 12 can be implemented to produce a horizontal schedule, a vertical schedule or a horizontal and vertical schedule in the form of a grid 98 as shown in FIG. 14 and that the schedule can be displayed at any angle including the surface of floors, ceilings or walls.

Alternatively, a plurality of light sources 34 as shown in FIG. 5 can be used without an aiming device 14 and produce a schedule 24 corresponding to the number of light sources 12. It can be appreciated that two or more light sources 12 can be used with or without an aiming device 14 producing any number of combinations of schedules 24 and/or grids 98.

In FIG. 1, the projection device 10 produces a plurality of beams of light 22 corresponding to a schedule 24 for attaching a sheet of wallboard to a framing member 26 (not shown). The projection device 10 produces a plurality of concentrated beams of light 18 in the form of a plurality of illuminated points 21, which correspond to a desired schedule 24. It can be appreciated that the illuminated points 21 of light are preferably circular; however, the points 21 can have any suitable shape, including but not limited to rectangular, square and/or oval or a plurality of segmented lines of illumination. In one embodiment, the projection device 10 can include a beam spreader 33 that forms a line (FIG. 4).

The device 10 can also includes a leveling device 16 as shown in FIG. 1. The leveling device 16 can be a spirit level or “bubble”, or center bubble for orientation or adjusting for level in either in either a horizontal or vertical plane. It can be appreciated that additional leveling devices 16 for orientation or adjustment of the device 10 in other planes including x (left/right), y (forward/backward) and z (up/down) can also be implemented.

As shown in FIG. 1, the leveling device 16 is a horizontal indicating level vial and positioned so as to permit plumbing the illuminated points of light 21 when the device 10 is used in a vertical plane, flat against a substantially vertical surface. Alternatively, the leveling device 16 can be an indicating vial, oriented so as to allow adjustment of the device to produce accurate spacing of points of illumination when the device is used against a substantially out of true surface. The leveling device 16 can also be a pair of leveling devices 16 at right angles to each other or any other desire angle.

Alternatively, the device 10 can be self-leveling, wherein the light source 12 is positioned within a housing (not shown) and as a result of the gravitational force the light source 12 is self-leveling. Typically, a self-leveling device 16 can include a light source 12 mounted on a pendulous platform suspended from a frame, which moves freely under the influence of gravity to provide automatic self-leveling.

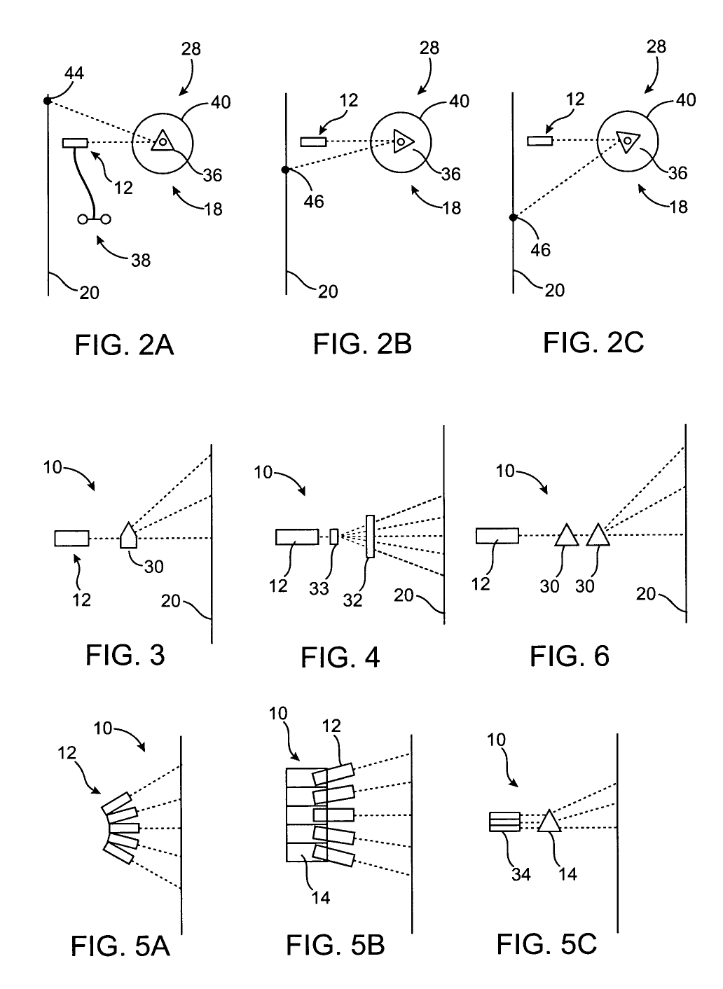

FIGS. 2-6 show various embodiments of the aiming device 14. For example, the aiming device 14 can be a motor and mirror assembly 28 (FIGS. 2A-2C), a beam splitter 30 configured to split the beam of light 18 into a plurality of beams of light 22 (FIG. 3), an aperture 32 adapted to allow only a certain portion of the beam of light 18 to show through the aperture 32 (FIG. 4), or a plurality of refractive optical assemblies or beam splitters 30 configured to receive a beam of light 18 and separate the beam 18 into a schedule 24 (FIG. 6). Alternatively, as shown in FIGS. 5A and 5B, the device 10 can comprises a plurality of light sources 34, wherein each light source 12 produces an individual beam of light 22 forming a schedule 24 on the surface 20. FIG. 5C shows a cross sectional view of a further embodiment of the device of FIG. 1 comprising a plurality of light sources and an aiming device 14.

FIGS. 2A-2C shows the aiming device 14 in the form of a motor and mirror assembly 28. The motor and mirror assembly 28 uses a mirror 36 and an electronic assembly 38 to redirect the light source 12. The mirror 36 (or array) is attachable to a motor assembly 40. The motor assembly 40 is configured to rotate the mirror 36 through a plurality of positions, which when combined with an intermittent light source, projects the beam of light 18 from the light source 12 onto the surface 20 in a plurality of illuminated points 21, which forms the schedule 24.

The light source 12 as shown in FIGS. 2A-2C is timed to the rotation and movement of the mirror 36. Preferably, at pre set intervals, the light source 12 is configured to switch on and off. Because the mirror assembly 28 is at an angle to the beam of light 18, the light source 12 preferably a laser light can be refracted to any spot on a wall or surface 20, depending on the angle of the mirror 36, combined with the timing of the beam of light 18 from the light source 12.

In addition, the device 10 can be programmed either by the user with an adjustment feature, manufacture or other entity in the distribution chain to a preset number of illuminated points 21 formed by each beam of light 18 projected from the mirror assembly 28 and forming a repeatable or variable schedule 24. In one embodiment, the device 10 includes a microprocessor or CPU 42. The microprocessor or CPU 42 is programmable, such that the device 10 can produce a plurality of schedules 24. In addition, the schedules 24 can be repeatable where the device 10 produces a schedule 24 having a constant distance of any selected distance or amount between each dot 21, or a variable schedule 24 where the distance between each dot 21 can vary.

The device 10 can also be programmable to provide the schedule 24 at a suitable timing sequence, wherein the timing sequence varies between approximately 0.001 to approximately 30.0 seconds between beams of light 18, and more preferably between about 0.01 and 1.0 seconds between beams of light 18. In addition, reference points 21 can be configured to a preset distance as a reference to compensate for any deviation or bow in a wall or a mounting alignment issue. Thus, the device 10 provides an accurate schedule 24 on any surface, regardless of alignment or placement.

It can be appreciated that the device 10 can also be used for anything from mounting wallboard (7 inch to 8 inch schedule), to nailing decking (16 inch schedule) to showing spacing for studs in new construction, to laying out tile, sewing quilts including where the illuminated points 21 form a pattern or other repeatable pattern, or any other application where a repeatable straight line schedule 24 is desired. In addition, a schedule 24 can be formed by producing a laser beam of light 18 through a laser line generator 33 and a segmented aperture 32, producing a straight line and having an absence of light in a segmented series of locations corresponding to the desired schedule 24.

FIG. 2A shows the device 10 having a light source 12, and an aiming device 14 in the form of a motor and mirror assembly 28. The light source 12 is preferably a laser light source connected to an electronic assembly 38, which is configured to control the intermittent timing of the beams of light 18. The beams of lights 18 are projected onto the motor and mirror assembly 28, wherein the beam of lights 18 reflect off of the mirror 36 onto the surface 20 at a first point 44.

FIG. 2B shows the device 10, wherein the motor assembly 40 of the motor and mirror assembly 28 rotates the mirror 36 such that the intermittent beam of light 18 reflects onto the surface 20 at a second point 46, wherein the first and second illuminated points 44, 46 are part of the schedule 24.

FIG. 2C shows the device 10, wherein the motor and mirror assembly 28 is configured to direct the intermittent beam of light 18 to a third illuminated point 48. The first, second and third illuminated points as shown in FIGS. 2A-2C form a repeatable schedule 24. It can be appreciated that the individual intermittent beams of light 22 are repeated at such a frequency that they appear to flash often enough that the illuminated points 21 remain visible to the human eye.

As shown in FIG. 3, the beam splitter 30 is preferably a diffractive optical assembly used to split a single beam of light 18 into a plurality of individual beams of light 22 with specified uniformity forming a schedule 24. It can be appreciated that the individual beams of light 18 can be arranged in a straight line at predetermined spacing, at right angles to one another forming a grid 98 (FIG. 14) or any other suitable arrangement. Typically, the beam splitter 30 comprises a system of mirrors and/or prisms. The light source 12 for the beam splitter 30 is preferably a laser; however, any other suitable light source 12 can be used.

Alternatively, the aiming device 14 can be a lens configured to receive the beam of light 18 from the light source 12 and separates the beam of light 18 into a plurality of beams 18 according to a schedule 24. The lens can be a prism, or other suitable device, which scatters the beam of light 18 into a schedule 24. In operation, the lens is positioned along an axis of the beam of light 18 separating the single beam of light 18 from the light source 12 into a plurality of light beams 18 forming a schedule 24.

In one embodiment, the aiming device 14 can be a prism, which is typically thicker at one end, such that the beam of light 18 passing through it is bent (refracted) toward the thickest portion. Typically, a lens can be thought of as two rounded prisms joined together. The beam of light 18 passing through the lens is always bent toward the thickest part of the prisms.

Alternatively, the aiming device 14 can be a lens in the form of a refracting device that rearranges the distribution of the beam of light 18, a prism, a diffraction device, a diverging lens or mirror, which causes incident parallel beams of light to be transmitted or reflected at an angle such that they never cross the central axis of the optical device, whereas the diverging lens is concave and a diverging mirror is convex.

FIG. 4 shows the aiming device 14 in the form of a line generator 33 and an aperture 32 configured to receive the beam of light 18 from the light source 12. The aperture 32 provides an exit for the line of light 18 generated by the light source 12 passed through the line generator 33. The aperture 32 comprises at least one opening that receives the line of light 18 and segments the beam of light 18 into a plurality of points of light each corresponding to an illuminated point 21 forming the schedule 24.

FIGS. 5A and 5B show the device 10 comprising a plurality of light sources 12. As shown in FIGS. 5A and 5B, the device 10 does not include an aiming device 14. Rather each of the light sources 12 projects a single beam of light 18 corresponding to the schedule 24. The plurality of light sources as shown in FIG. 5B are adjustable, wherein the spacing between the illuminated points 21 can be adjusted by the user. Alternatively, as shown in FIG. 5C, an aiming device 14 in the form of a beam splitter 30 or lens 32 can be used, which receives the beam of light 18 from the light source 12 and separates each of the beams of light 18 into a plurality of beams of light 18.

FIG. 6 shows the projection device 18 comprising a plurality of beam-converging beam splitters 30 in the form of a prism at positions along an axis of the light source 12 produces a beam of light 18, and focuses a different portion of the beam 18 to a different distance with each of the plurality of beam splitters 30 or mirrors 26. As shown in FIG. 6, the beam of light 18 from the light source 12 can be projected through a plurality of prisms instead of a single lens as shown in FIG. 3. In operation, the beam of light 18 achieves similar beam distribution and focuses as the other examples show.

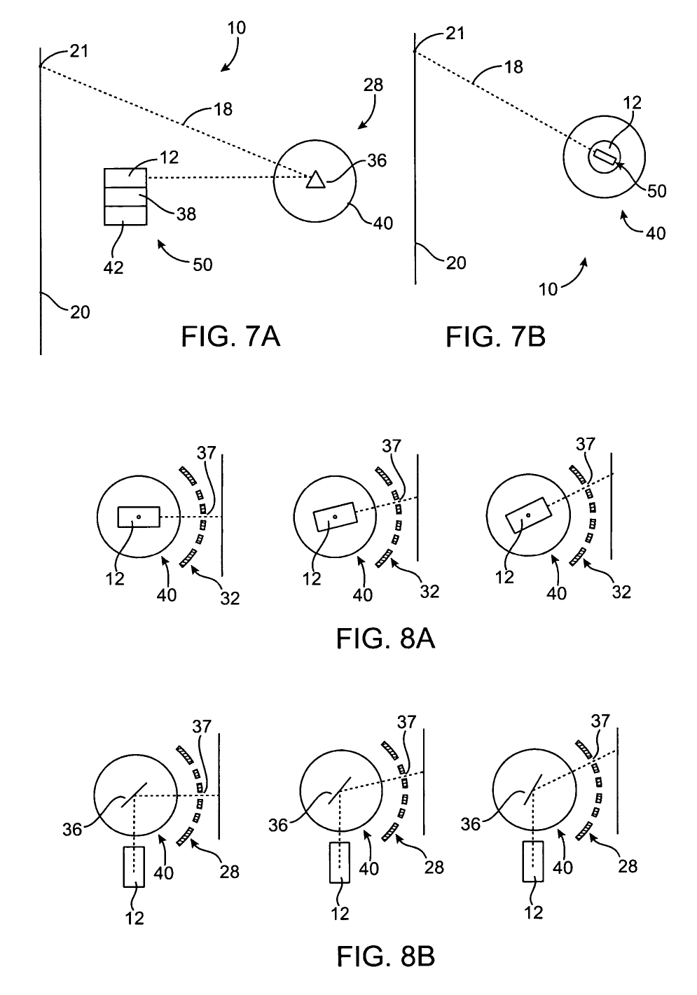

FIG. 7A shows the light source 12 and mirror assembly 28 of FIGS. 2A-2C. As shown in FIG. 7A, the mirror assembly 28 comprises a mirror 36 and a motor assembly 40. The motor assembly 40 typically comprises a motor, such as servomotor, a direct drive motor or other suitable motor, and a gear system. An electronic assembly 38 is adapted to control the intermittent timing of the emission of the beam of light 18 by the light source 12.

The light source 12, the electronic assembly 38 and the microprocessor or CPU 42 form a light assembly 50. In operation, the electronic assembly 38 and the microprocessor or CPU 42 control the intermittent timing of the flashing of the beams of light 18 and the operation of the motor and mirror assembly 28. In addition, the microprocessor or CPU 42 is configured to adjust the schedule 24 by changing the intermittent timing of the flashing of the beams of light 18 from the light source 12, and the rotational angle of the mirror 36 of the motor and mirror assembly 28.

It can be appreciated that a wireless control device (not shown) can be used with the microprocessor 42 to adjust and/or change the schedule 24 without having to physically access the device 10. For example, if a fence contractor is installing fence posts every eight (8) feet in one area and for certain reasons such as the slope of a hill the schedule 24 needs to be reduced to every six (6) feet, the schedule 24 could be remotely changed without the need to physically access the device 10.

FIG. 7B shows an alternative embodiment of the device 10 comprising a light source assembly 50 and motor assembly 40. Rather than rotating the mirror 36 of the motor and mirror assembly 28 as shown in FIG. 7A, the light assembly 50 includes a rotatable light source 12. The light source 12 projects a plurality of beams of light 18 onto the surface 20 forming a schedule 24. As shown in FIG. 7B, the light source 12 and light assembly 50 can project beams of light 18 through a complete revolution of 360 degrees onto a surface 20 as the light source 12 rotates.

FIG. 8A shows a cross sectional view of a further embodiment of the device of FIG. 1 having a rotatable light source 12 and an aperture 32. As shown in FIG. 8A, the device 10 graphically shows a schedule 24 and comprises at least one light source 12 adapted to emit a visible beam of light 18 and a motor assembly 40 adapted to rotate the light source 12 through a plurality of positions. The light source 12 projects the beam of light 18 onto an aperture 32, which only allows the beam to pass through at intermittent points 37 to the surface in the form of individual illuminated points corresponding to a schedule 24.

FIG. 8B shows a cross sectional view of another embodiment of the device 10 of FIG. 1. As shown in FIG. 8B, the device 10 comprises a light source 12, a rotatable mirror assembly 28 and an aperture 32. The device 10 includes at least one light source 12 adapted to emit a visible beam of light 18; a mirror 36 configured to receive the beam of light 18; and a motor assembly 40 adapted to rotate the mirror 36 through a plurality of positions. The mirror 36 receives the beam of light 18 and projects the beam of light 18 onto an aperture 32, which only allows the beam to pass through at intermittent points 37 to the surface in the form of individual illuminated points corresponding to a schedule 24.

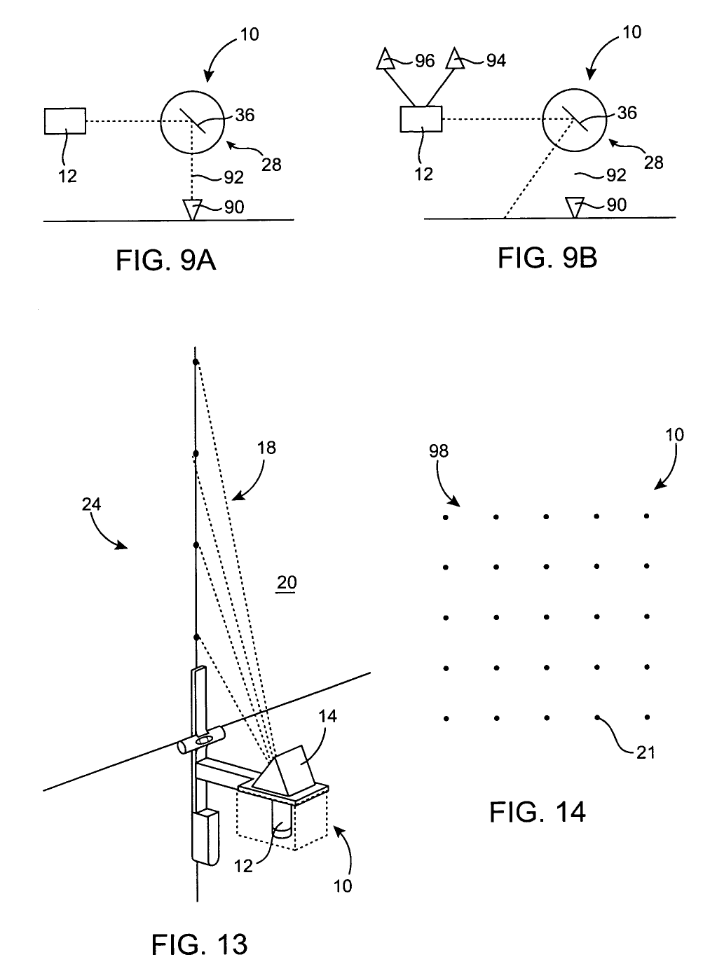

FIGS. 9A and 9B show the device 10 having a photocell or photodiode 90 for calibrating the device 10 to a desired schedule 24. As shown in FIG. 9A, the device 10 comprises a light source 12 in the form of a laser, a motor and mirror assembly 28 and the photocell or photodiode 90. The photocell or photodiode 90 is configured to detect the time it takes for the mirror 36 to make a single revolution. Once the photocell or photodiode 90 detects the time for a single revolution, the information can be used to determine the speed of the motor and mirror assembly 28 for calculating the intermittent timing of the light source 12. As shown in FIG. 9A, the photocell 90 communicates with the light source 12 by providing the intermittent timing of light beams 18 to produce a plurality of illuminated points 21 forming a schedule 24.

FIG. 9B shows the device 10 having a light source 12 in the form of the laser, wherein the light source 12 directs an index point 92. If the index point 92 is not received at a predetermined point 93, i.e., the index dot 92 is too close to the device 10, i.e., the index point 92 is received at a non-predetermined point 95, an adjustment device 94 adjusts the speed of the motor and/or mirror assembly 28. The adjustment device 94 is preferably connected to the microprocessor or CPU 42 and communicates with the motor and mirror assembly 28, and more particularly the motor assembly 40 to program the timing of the device 10 such that the index point 92 strikes the predetermined point 93.

Alternately, once the rotating speed of the motor and/or mirror assembly 28 has been determined by the CPU 42, the timing of the intermittent flashing of the laser 12 can be adjusted by an adjustment device 96 calibrating the index point 92 to the predetermined point 93.

It can be appreciated that the device 10 can also be calibrated by having a schedule 24 having a known end point or dot 21 corresponding to a standard or known distance. For example, if affixing wallboard to a stud, wherein the wallboard has a known length, for example four (4) feet, the known end point or dot 21 is projected to an edge of the wallboard. If the known end point or dot 21 does not project to the edge of the wallboard or known length, the user can determine that the device 10 needs to be calibrated and electronically or manually redirect the end point to standard.

In operation, the device 10 will typically be placed on the surface 20 in which the plurality of beams of light 22 is projected forming the schedule 24. It can be appreciated that the device 10 can be placed adjacent to the surface 20 preferably at a right angle to the surface 20. However, the device 10 can be positioned adjacent to the surface 20 at non right angles.

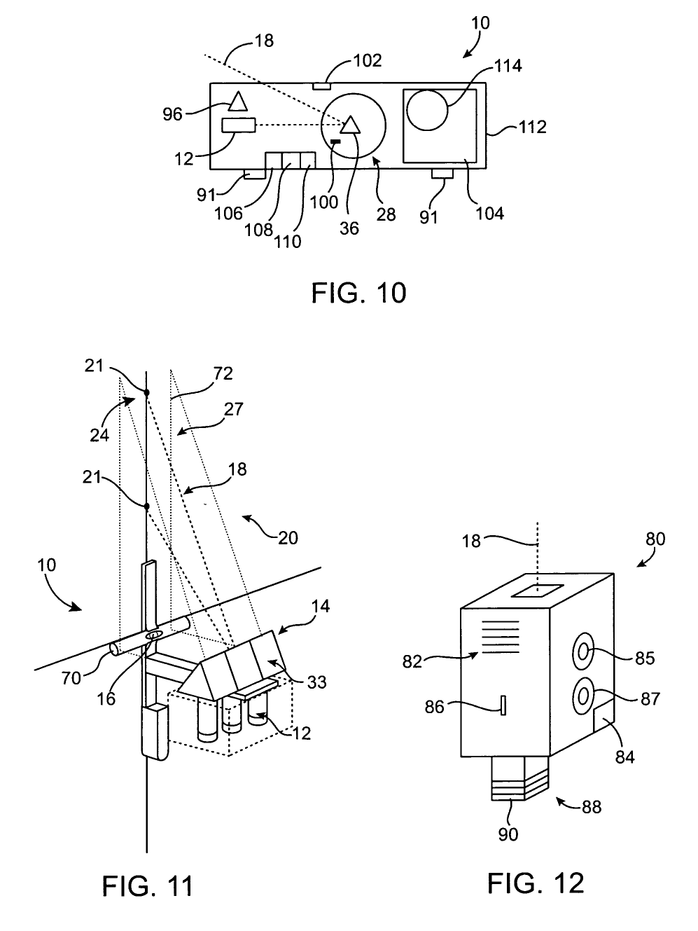

As shown in FIG. 10, if necessary, the device 10 can be adjusted on the x, y or z-axis using a series of adjustment feet 91 in connection with the leveling devices 16. The adjustment feet 91 allow the leveling of the device 10 on horizontal or vertical surfaces. In operation, the leveling devices 16 provide a means to level the device 10 to insure the accuracy of the schedule 24.

As shown in FIG. 1, the leveling devices 16 will preferably be a built in vial or bubble indicator. However, it can be appreciated that the leveling devices 16 can be a suitable self-leveling or automatic leveling device 16.

Once the device 10 is positioned on the desired surface and leveled using the leveling devices 16, the device 10 is turned on. The device 10 can include an on/off switch 86 (FIG. 12) or other suitable device or switch to activate the light source 12. Using an indexing dial 85 (FIG. 12), the index dot 92 as shown in FIGS. 9A and 9B is adjusted to a pre-selected distance. Once the device 10 is calibrated, a desired distance between points can be selected using a spacing dial 87 (FIG. 12) or other suitable means including a switch, or lever type device. It can be appreciated that the spacing dial 87 can automatically provide the maximum number of illuminated points 21 (or segments) possible over its range. In addition, it can be appreciated that the distance between each of the illuminated points or segments can vary from about a ⅛ of an inch to about 10 feet.

If the device 10 is being used to determine fastening locations along a hidden line (such as a stud behind wallboard) and the line is known to be plumb, then referring to the plumb vials or leveling devices 16, the device can also be adjusted so that it is plumb. Typically, it will be assumed that the device 10 is level; however, this can be verified by the leveling device 16. However, if the device 10 is not level, the device 10 can be level by adjusting an index dot 92 (FIG. 9A) and placing the predetermined point 93 at a known predetermined distance from the device 10 (FIG. 9B). The device 10 will then automatically compensate for an out of level (either horizontal or vertical) condition.

Alternatively, it can also be appreciated that the device 10 can be made level by placing the device 10 above the surface 20 by mounting the device 10 on a tripod or other elevated platform and adjusting the device 10 such that each of the leveling devices 16 are level.

FIG. 11 shows a perspective view of the device 10 in operation. The device comprises a light source 12 in the form of a laser diode projecting a point of visible light 18 onto a surface 20 using an aiming device 14 in the form a plurality of light sources. As shown in FIG. 11, the aiming device 14 is configured to display the beam of light 18 into a plurality of illuminated points 21 corresponding to a schedule 24. It can be appreciated that for some uses a reference point at a known distance will be used to take into account any deviations or bends in the surface 20.

As shown in FIG. 11, the device 10 can also include a locating device 70 (or “stud finder”) for locating wall studs or floor joists. The locating device 70 is configured to graphically display at least one edge 72 of the framing member (not shown). As shown in FIG. 11, the line of light 18 from the light source 12 and directed through the line generator 33 provides a graphical locater of the edge of the framing member. The beam of light 18 is projected onto the surface 20 in the form of a line 23 onto the sheet of drywall. Thus, the beam of light 18 can be aligned with indicators showing an edge of the framing member, the drywall, and including adjusting the device 10 so that the projected line 23 is in vertical orientation on the surface 20.

Typically, the locating device 70 is configured to sense the location of a framing member such as a stud or joist by density. However, any other suitable means can be used to locate the stud or joist for installation of wallboard and other wall materials. If a locating device 70 is present with the device 10, the light source 12 can also provide a beam of light 18 corresponding to one edge of the framing member or alternatively, the aiming device 14 can display a separate pair of beam of light 18 corresponding to each edge of the framing member.

As shown in FIG. 11, the aiming device 14 directs the beam of light from the light source 12 into a single point of illumination 21 for a single nail or screw hole, a plurality of beams of light 18 configured to having a plurality of light points or a beam of light 18 in the form of a thin beam of light which forms a line 23 showing an edge of a stud or beam.

FIG. 12 is a perspective view of the device 10 further comprising a housing 80, which may be made of plastic or other suitable material such as metal. The housing 80 can also possess a griping member 82 for handling. The griping member 82 is preferably made of an elastomeric substance for ease of use; however, any suitable material can be used. As shown, the housing 80 contains the light source 12 and the aiming device 14. The housing 80 can be a self-contained system containing the light source 12 and the aiming device 14 or merely as an attachment for attaching one or all of the components of the device 10 thereto.

The housing 80 can also include a power source 84 in the form of a battery for powering the light source 12. In addition, the power source has an on/off switch 86. The on/off switch 86 selectively powers the light source 12.

It can be appreciated that the device 10 can further include an attachment member 88, which is configured to attach the device 10 to a surface 20 such as stud or framing member. The attachment member 88 can be a clamp, a bracket, a magnet, an adhesive, a non slip surface, an opening to attach the device to a nail or screw, a pin or tab that protrudes from the device or any suitable component that will allow the device 10 to be attached or secured to a specific location. It can be appreciated that the attachment member 88 does not require that the device 10 be secured to a wall or surface, rather in one embodiment the attachment member 88 provides a non-slip surface.

In another embodiment, the device 10 can include an adjustable member 90, which is configured to adjust for wallboard, wall or other surfaces which are not necessarily flat. Typically, if the light source 12 is positioned only slightly off of the surface 20 that the light beam 18 is projecting onto, it is possible that if the surface 20 is bowed or uneven, an error in the schedule 24 can occur as a result of the light beam 18 contacting the surface 20 at a location other than the desired location. However, by adjusting the distance from the surface 20 to the device 10 including the aiming device 14, the device 10 can compensate for any unevenness or bowing of the surface 20. The adjustment member 90 can include a thumbscrew or any other suitable device to adjust the distance from the aiming device 14 to the surface 20.

In another embodiment, as shown in FIG. 10, the device 10 comprises a light source 12 in the form of a laser, at least one timing chip 100, a photocell or photodiode 102, a PC board 104, a microprocessor or CPU 42 comprising a motor control 106, a laser control 108, and an electronic assembly 110, a housing 112, a mirror 36, motor assembly 40, and a battery assembly 114. The at least one timing chip 100 receives a series of signals from the microprocessor 42 to control the rotation of the mirror 36 and the intermittency of the beam of light 18 from the light source 12.

In operation, the photocell or photodiode 102 as shown in FIGS. 9A and 9B is configured to detect the time it takes for the mirror to make a single revolution and uses this information to determine the speed of the motor and mirror assembly 28 and control the intermittent flashing of the light source 12.

In operation, it can be appreciated that the microprocessor 42 of the device 10 or by interchangeable beam splitter 30, apertures 32, and light sources 34 can be programmable or adjusted to provide different nailing or screwing schedules for different materials and/or configurations. For example, as shown in FIG. 12, the device 10 can be programmable for fastening drywall panels to a framing member 26. Typically, screws are positioned along each edge and each framing member, spacing them every 12 inches for ceilings and 16 inches for walls. The device 10 can be designed having a fixed schedule, for example 12 inches, 16 inches or 24 inches, provided with a plurality of projections devices that can be interchangeable to provide a variable schedule 24 or alternatively, the microprocessor 42 can be programmable to provide a variable schedule 24 to meet the needs of the materials pursuant to guidelines for attaching drywall panels or other materials to framing members or other framing members or surfaces 20.

It can be appreciated that the device 10 would typically be used to display a fastening schedule 24 for drywall, sheetrock or other material onto the face of a wall. However, it can be appreciated that the device 10 can be used on floors, ceilings, decks or any suitable surface 20 where a schedule 24 is needed.

While the invention has been described in detail with reference to the preferred embodiments thereof, it will be apparent to one skilled in the art that various changes and modifications can be made and equivalents employed, without departing from the present invention.

1. A projection device that graphically shows a schedule comprising:
at least one light source adapted to emit a beam of light; and
an aiming device adapted to receive the beam of light and project the beam of light onto a surface, wherein the projection device produces a plurality of illuminated points or segments corresponding to a schedule.

2. The device of claim 1, wherein the projection device further comprises an electronic assembly adapted to control the intermittent timing of the emission of the beam of light by the light source.

3. The device of claim 2, further comprising a mirror assembly, wherein the mirror assembly comprises a mirror and a motor assembly, wherein the motor assembly rotates the mirror through a plurality of positions, and wherein the mirror projects intermittent beam of light onto the surface.

4. The device of claim 3, wherein the mirror assembly further comprises a photoelectric cell configured to determine a rotational speed of the motor assembly.

5. The device of claim 2, wherein the electronic assembly further comprises a microprocessor adapted to be programmable for a series of schedules.

6. The device of claim 1, further comprising at least one leveling device.

7. The device of claim 1, wherein the aiming device is a beam splitter configured to separate the beam of light into the plurality of beams of light.

8. The device of claim 1, wherein the aiming device is a refraction device configured to separate the beam of light into the plurality of beams of light.

9. The device of claim 1, wherein the aiming device is an aperture adapted to allow a segment of the beam of light to show through the aperture.

10. The device of claim 1, wherein the projection device comprises a plurality of light sources, wherein each light source produces an individual beam of light.

11. The device of claim 1, further comprising a microprocessor configured to produce a plurality of schedules.

12. The device of claim 1, wherein the light source is a laser adapted to produce a laser beam of light.

13. The device of claim 12, wherein the aiming device comprises a plurality of lenses at positions along an axis of the beam of light, and focusing a different portion of the beam to a different distance with each of the plurality of lenses.

14. The device of claim 1, further comprising a locating device configured to illustrate at least one edge of a framing member.

15. The device of claim 13, further comprising a photocell and an adjustment device, wherein the adjustment device is configured to adjust a timing sequence for the motor and mirror assembly.

16. The device of claim 13, further comprising a photocell and an adjustment device, wherein the adjustment device is configured to adjust the timing sequence for the light source.

17. The device of claim 1, wherein the leveling device is at least two bubble levels at right angles to each other.

18. A device that graphically shows a schedule comprising:
at least one light source adapted to emit an intermittent visible beam of light;
an electronic assembly adapted to control the intermittent timing of the emission of the beam of light by the light source; and
a motor assembly adapted to rotate the light source through a plurality of positions, and project the intermittent beam of light onto a surface in the form of individual points of illumination corresponding to a schedule.

19. The device of claim 18, wherein the electronic assembly further controls the rotation of the motor assembly.

20. The device of claim 18, further comprising a refracting optic assembly configured to receive the intermittent beam of light and redirect the beam of light onto a surface in the form of individual points of illumination corresponding to a schedule.

21. A device that graphically shows a schedule comprising:
at least one light source adapted to emit an intermittent visible beam of light;
a mirror configured to receive the beam of light;
a motor assembly adapted to rotate the mirror assembly through a plurality of positions;
an electronic assembly adapted to control the intermittent timing of the emission of the beam of light by the light source; and
wherein the mirror receives the beam of light and projects the beam of light onto a surface in the form of individual points of illumination or segments corresponding to a schedule.

22. The device of claim 21, wherein the electronic assembly further controls the rotation of the motor assembly.

23. The device of claim 21, further comprising a refracting optic assembly configured to receive the intermittent beam of light and redirect the beam of light onto a surface in the form of individual points of illumination corresponding to a schedule.

24. A device that graphically shows a schedule comprising:
at least one light source adapted to emit a visible beam of light;
a laser line generator adapted to convert the beam of light into a line of light;
an aperture assembly configured to control the emission of the beam of light; and
wherein the beam of light is beamed onto a surface in the form of a plurality of individual points of illumination or segments corresponding to a schedule.

25. A device that graphically shows a schedule comprising:
at least one light source emitting a visible beam of light;
a mirror configured to receive the beam of light, wherein the mirror receives the beam of light and projects the beam of light;
a motor assembly adapted to rotate the mirror through a plurality of positions;
an aperture assembly configured to control the emission of the beam of light; and
wherein the beam of light is beamed onto a surface in the form of a plurality of individual points of illumination or segments corresponding to a schedule.

26. A device that graphically shows a schedule comprising:
at least one light source adapted to emit a visible beam of light;
a motor assembly adapted to rotate the light source through a plurality of positions;
an aperture assembly configured to control the emission of the visible beam of light; and
wherein the visible beam of light is beamed onto a surface in the form of a plurality of individual points of illumination or segments corresponding to a schedule.
